(19) United States
(12) Patent Application Publication
(10) Pub. No.: US 2021/0339378 A1
(43) Pub. Date: Nov. 4, 2021

(54) Hand-Held Door Manipulator

(71) Applicant: Adrian Rivera, Whittier, CA (US)

(72) Inventor: Adrian Rivera, Whittier, CA (US)

(21) Appl. No.: 16/865,294

(22) Filed: May 1, 2020

(51) Int. Cl. B25J 1/00; A01N 59/20; A01N 59/16; A01N 25/34

(52) U.S. Cl. CPC B25J 1/00; A01N 25/34; A01N 59/16; A01N 59/20

(57) ABSTRACT

A door manipulation tool includes a grip end, a working end, and a connector. The grip end is configured to be gripped by a user. The working end is configured to contact and grasp a door element. The connector is configured to maintain a spaced relation between the grip and working ends. The working end can include a hook, a loop, a grabber, and/or a prod. The tool can be fabricated from or plated with an antimicrobial material, such as an antiviral material. The tool can include a holster, and a closure element arranged between the grip end and the connector, configured to couple with an opening of the holster and mutually arranged as a bottle opener. An interior of the holster can include a fabric lining that is configured to absorb and release an antimicrobial liquid. The connector can include indicia configured to measure a distance between two points.

### FIELD OF THE INVENTION

The present invention relates to hand-held devices configured to open, close, and otherwise manipulate a door without having to touch the door with the hands.

### BACKGROUND OF THE INVENTION

Public spaces have many surfaces that can be touched by the hands of numerous people over the course of a typical day. Some of these surfaces are cleaned on a regular basis, whereas others are not. Even surfaces that are cleaned regularly can be touched by dozens of people between cleanings. These surfaces can collect various germs, bacteria, and viruses from the people who contact them, and some of these microbes can continue to live on these surfaces for days. A person who subsequently contacts a contaminated surface risks becoming a host for any type of contaminant on the surface, which can be passed to others who come into contact with that person, which in turn can lead to illness. People who are aware of this danger can avoid contamination by avoiding unnecessary contact with surfaces in public places, However, it is often difficult or impossible to avoid touching door handles, latches, and push plates in public buildings. Not only is touching door elements necessary, but because doors are in constant use during certain times of day, it is impossible to keep surfaces sanitized during those times.

The proliferation of germs and the associated spread of sickness could be diminished if doors could be opened and closed without human contact. Many public spaces have automated doors that open when someone approaches, and some doors are equipped with mechanisms that allow doors to be opened using a foot. However, if a person encounters a door that is not so equipped, contact with the door is necessary. Therefore, it would be beneficial to provide a door-manipulating implement that can be carried by a person, for use with any door that is encountered.

### BRIEF SUMMARY OF THE INVENTION

According to an aspect of the invention, a door manipulation tool includes a grip end, a working end, and a connector. The grip end is configured to be gripped by a user. The working end is configured to contact and grasp a door element. The connector is configured to maintain a spaced relation between the grip end and the working end.

The grip end can be, for example, a handle, and can include a loop configured to be held by a finger, and/or a loop configured to be coupled to a key chain.

The working end can include, for example, a hook, a loop, a grabber, and/or a prod.

At least the working end can be fabricated at least in part from an antimicrobial material. For example, the antimicrobial material can be gold, silver, copper, alloys of copper, cobalt, nickel, zinc, zirconium, molybdenum, and/or lead. The antimicrobial material can be, for example, an antiviral material.

At least the working end can be plated at least in part with an antimicrobial material. For example, the antimicrobial material can be gold, silver, copper, alloys of copper, cobalt, nickel, zinc, zirconium, molybdenum, and/or lead. The antimicrobial material can be, for example, an antiviral material.

The tool can also include an antimicrobial fabric covering configured to closely cover at least the working end.

The tool can also include a disposable covering configured to closely cover at least the working end.

The tool can also include a holster configured to contain at least the working end. In this case, the tool can include a closure element arranged between the grip end and the connector, which is configured to couple with an opening of the holster. The closure element and the working end can be mutually arranged as a bottle opener. The holster can be, for example, a rigid case. The holster can include fabric. For example, the fabric can be an antimicrobial fabric. An interior of the holster can include a fabric lining that is configured to absorb and release an antimicrobial substance. The antimicrobial substance can be, for example, a liquid and/or a powder. The tool can include the antimicrobial substance, infused within the fabric lining. An interior of the holster can include a fabric lining that is configured to absorb and release a sanitizer. The tool can include the sanitizer, infused within the fabric lining.

The tool can include a pad configured to be disposed within the holster. The pad can be further configured to absorb an antimicrobial substance. The antimicrobial substance can be, for example, a liquid and/or a powder. The pad can further include the antimicrobial substance, infused within the pad. The pad can be fabricated from an antimicrobial fabric. The pad can be further configured to absorb a sanitizer. The tool can further include the sanitizer, infused within the pad.

The tool can include a pouch configured to be disposed within the holster. The pouch can be further configured to contain one or more antimicrobial pellets. The tool can include the one or more antimicrobial pellets, contained in the pouch.

An interior of the holster can include an ultraviolet light source. The holster can also include a battery configured to power the ultraviolet light source. The battery can be a rechargeable battery, and the holster can include a port by which the battery can be coupled to a power source.

The holster can include a light source configured to shine outward from the holster, a rechargeable battery, and a port by which the battery can be coupled to a power source.

The grip end, the working end, and/or the connector can include a light source configured to shine outward from the tool, a rechargeable battery, and a port by which the battery can be coupled to a power source. Preferably, the light source is arranged on the working end.

The holster can include a loop configured to be coupled to a keychain. The holster can be configured to be coupled to the grip end.

The connector can include indicia configured to measure a distance between two points.

### BRIEF DESCRIPTION OF THE DRAWINGS

FIG. 1 is a view of an exemplary embodiment of the tool of the invention.

FIG. 2 is a view of an exemplary embodiment of the tool of the invention.

FIG. 3 is a view of an exemplary embodiment of the tool of the invention.

FIG. 4 is a view of an exemplary embodiment of the holster of the invention.

FIG. 5 is a view of an exemplary embodiment of the tool of the invention, including a closure element 8.

FIG. 6 is a view of an exemplary embodiment of the tool of the invention, including a closure element 8.

FIG. 7 is a view of an exemplary embodiment of the tool of the invention, including a closure element 8.

FIG. 8 is a view of an exemplary embodiment of the tool of the invention, including a holster.

FIG. 9 is a view of an exemplary embodiment of the tool of the invention, including a holster.

FIG. 10 is a view of an exemplary embodiment of the tool of the invention, including a holster.

### DETAILED DESCRIPTION OF THE INVENTION

The invention is a tool that can be used to open and close doors by a user without touching the door or anything but the tool by the user. By using the tool, the user can avoid coming into contact with the door, and therefore also with germs and other microbes present on the door due to contact from other people. As used herein, the term “microbes” takes its general meaning, that is, microorganisms that can include viruses, bacteria, protozoa, fungi, algae, amoebas, and slime molds. Similarly, “germ” means a microbe that can cause illness or disease.

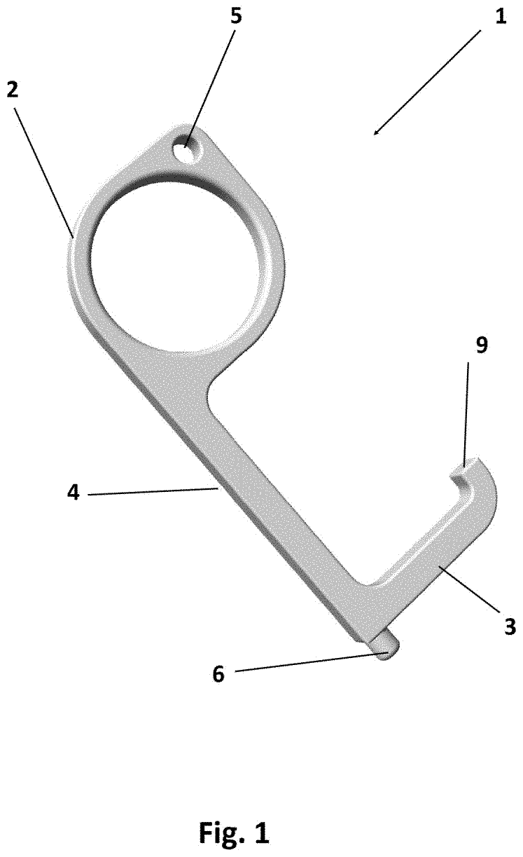

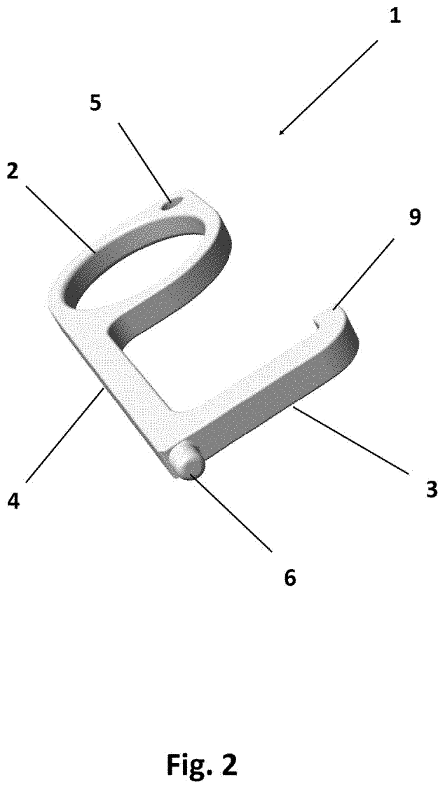

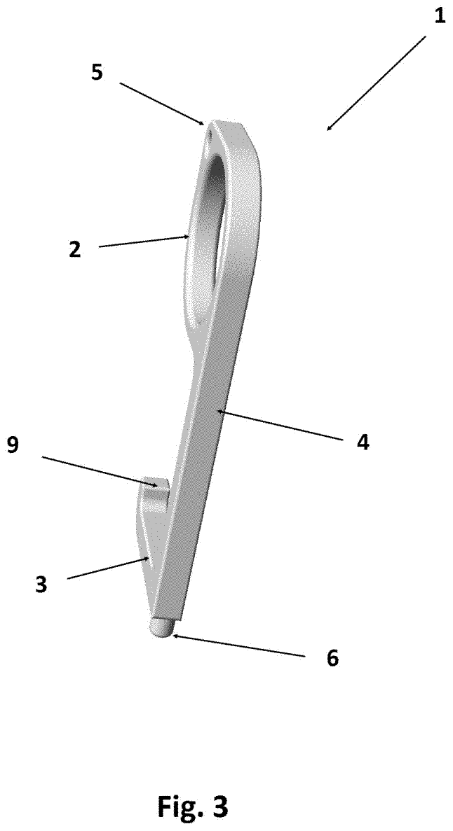

Referring to FIGS. 1-3, a door manipulation tool 1 according to the invention includes a grip end 2, a working end 3, and a connector 4, which can be formed as an integrated unit or as attached modular components. The grip end 2 is configured to be gripped and held by a user in order to direct the working end 3. The working end 3 is configured to contact and grasp, pull, or push a door handle, a door knob, a door edge, a door latch, or any other door element. The connector 4 is configured to connect the grip end 2 to the working end 3, and to space the grip end 2 from the working end 3 in order to keep a user's hand a safe distance from the door.

The grip end 2 can be configured as any structure that can be firmly gripped by a user in order to manipulate the tool 1. For example, the grip end 2 can be configured as a simple handle. As shown in FIGS. 1-3, the grip end 2 can include a loop or ring configured to be held by a finger in order to pull the tool 1 to open a door. The grip end 2 can include multiple such loops to be held by multiple fingers, and a thumb brace to help in grasping the grip end 2. The grip end 2 can also include a loop or other aperture 5 configured to be coupled to a key chain, to a belt chain, or to anything else for the convenience of the user.

The working end 3 can include any implement that can be used to pull or push a door open. For example, the working end 3 can be or include a hook that can be used to grab a door handle, door latch, or door edge to pull open the door. The hook can be squared off or rounded. Instead, or in addition, the working end 3 can include a loop for encircling a handle or latch, a prehensile grabber for manipulating latches, and/or a prod 6 for pushing open doors.

As described, the tool 1 can help protect the user by providing distance between the door and the user, who avoids touching a surface that might be contaminated by germs or other microbes. Further protection can be provided through the use of an antimicrobial material, either as the basic material from which all or part of the tool 1 is constructed, or as a covering for all or part of the tool 1. Such materials include those that are naturally resistant to microbes, that provide an inhospitable host surface for microbes, that tend to destroy, or inhibit growth and proliferation of microbes, or that are resistant to hosting microbes.

For example, all or part of the tool 1, and preferably at least the working end 3, can be formed from an antimicrobial material such as gold, silver, copper, alloys of copper (such as brass and bronze), cobalt, nickel, zinc, zirconium, molybdenum, and/or lead, or any other solid material having antimicrobial properties. In particular, the antimicrobial material can be, for example, an antiviral material. In order to minimize cost or weight of the tool 1, all or part of the tool 1 can be made from a common material such as plastic, wood, or bamboo that is plated or otherwise coated with the antimicrobial material.

As an alternative, the tool 1 can be covered with a sheath that form-fits to at least the working end 3 of the tool 1, like a removable glove that can be replaced after each use. This covering can be made from a disposable material for single-use application, or can be made from fabric that can be washed and re-used. If made from fabric, the covering can be an antimicrobial fabric covering. Such a fabric can be made from a material that is naturally antimicrobial, or can be treated to have antimicrobial properties. For example, certain textiles such as cotton, wool, polyester, polyester-vinyl composites, vinyl, and acrylics can be treated or embedded with an antimicrobial agent, or, for example, copper or silver threads can be woven into the fabric.

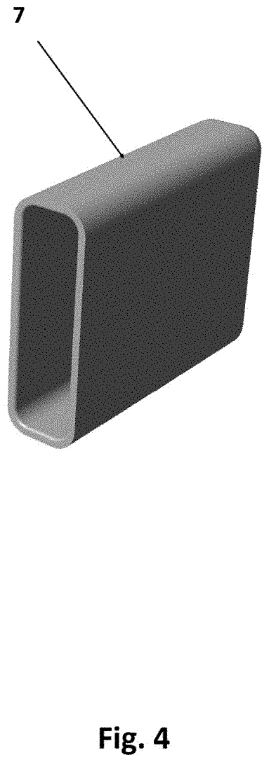

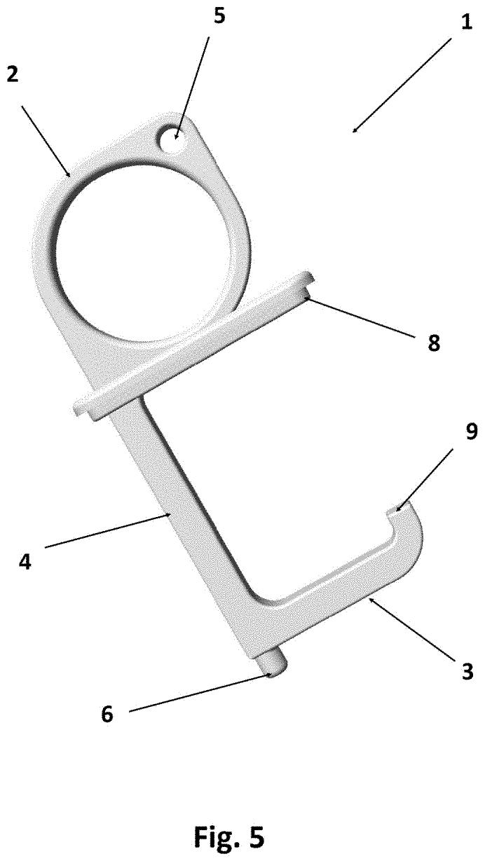

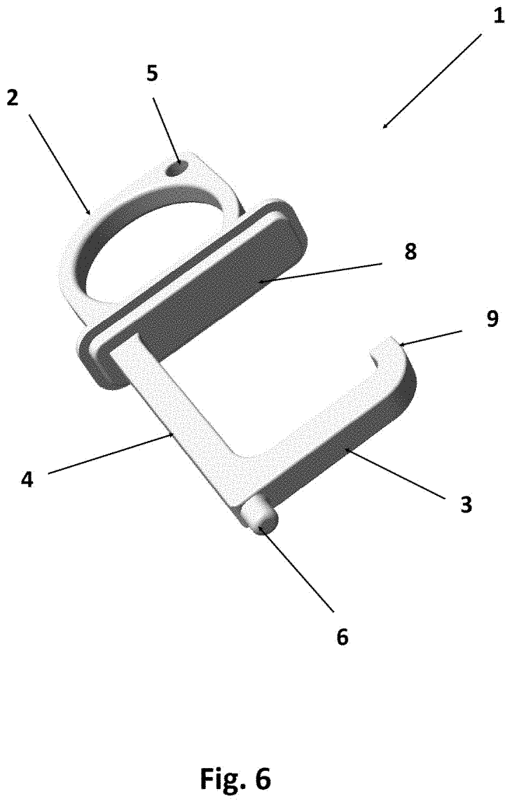

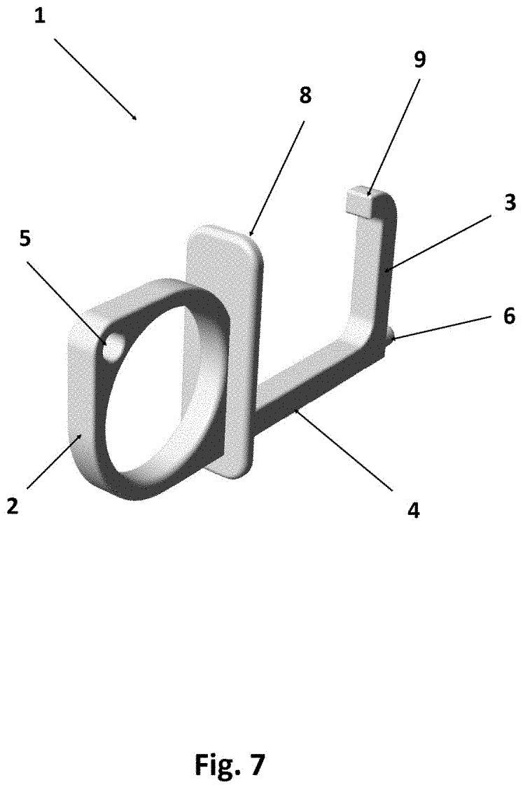

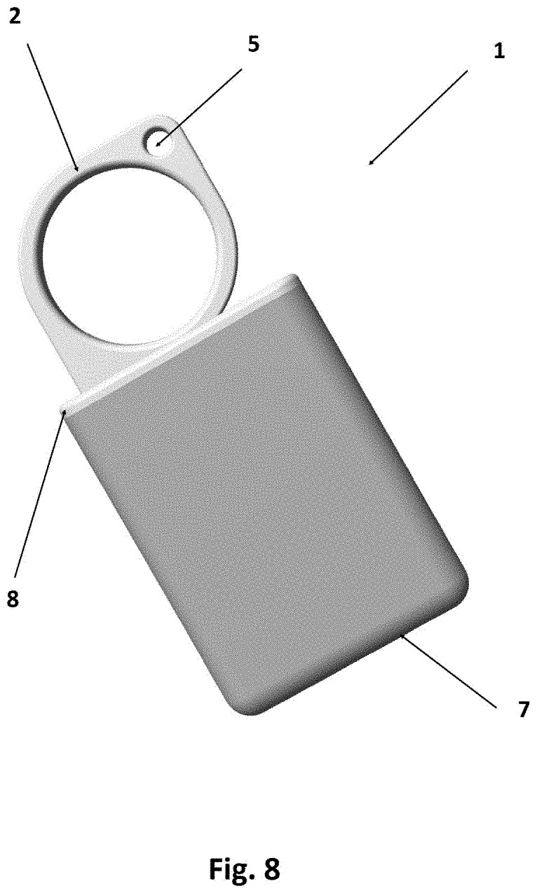

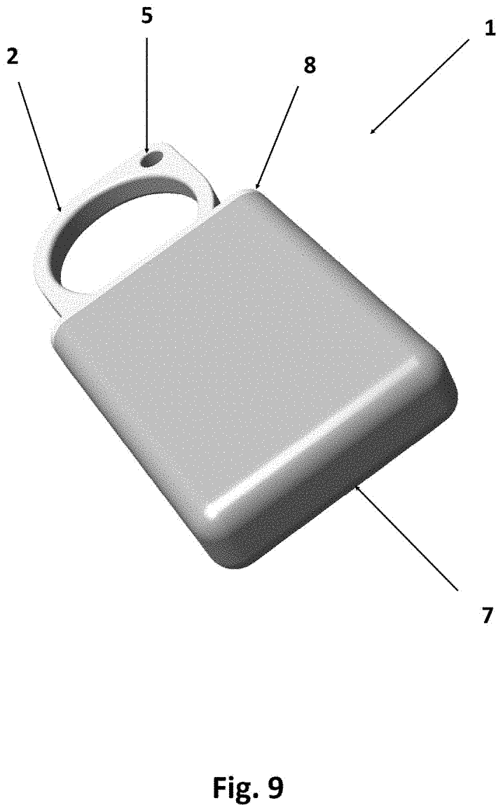

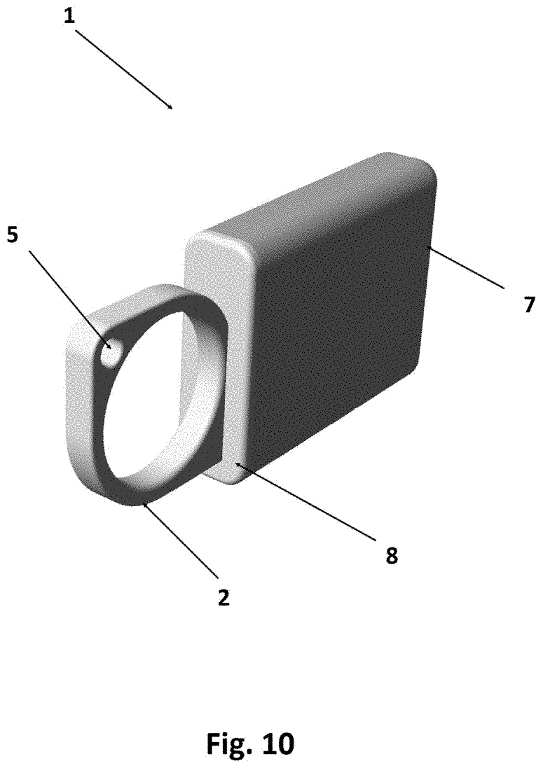

Referring to FIG. 4, the tool 1 can also include a holster 7 configured to contain at least the working end 3 of the tool 1 until it is to be used by the user, and into which the user can insert the working end 3 after use, to avoid touching and contaminating anything through contact with the tool 1 after use. Referring to FIGS. 5-7, in this case, the tool 1 can include a closure element 8 arranged between the grip end 2 and the connector 4, which is configured to couple with an opening of the holster 7 so that the working end 3 and connector 4 are enclosed within the holster 7, as shown in FIGS. 8-10. The closure element 8 can couple with the holster 7 by friction fit, snap fit, or any other mating arrangement. The closure element 8 also forms a physical barrier between the grip end 2 and the rest of the tool 1, further isolating the portion of the tool 1 that the user touches from the rest of the tool 1, and encloses the contaminated portion of the tool 1 within the holster 7 after use. As shown, the closure element 8 and the working end 3 can be mutually arranged for use as a bottle opener. For example, the end 9 of the hook of the working end 3 can be wedged under the edge of a bottle cap, and leverage provided by the closure element 8 or the connector 4 can be used to pry the bottle cap from a bottle.

The holster 7 can be, for example, a rigid case. The holster 7 can be entirely rigid like a case, or can include fabric, or can be made completely of fabric like a pouch. Any fabric used as part of the holster 7 can be an antimicrobial fabric. Even if the holster 7 is rigid, at least a portion of an interior of the holster 7 can include a fabric lining, which preferably is configured to absorb and release an antimicrobial substance, or which is embedded with an antimicrobial substance. The tool 1 as provided can include the antimicrobial substance, infused within the fabric lining, or the substance can be added later by the user. The antimicrobial substance can neutralize any contaminant that adheres to the working end 3 after use when the working end is inserted into the holster 7.

Alternatively, or in addition, the interior of the holster 7 can include a fabric lining that is configured to absorb and release a sanitizer, that is, a cleaning agent that typically includes bleach, or a solution that is at least 70% alcohol, such as ethyl alcohol or rubbing alcohol. The tool 1 can include the sanitizer, infused within the fabric lining, or the sanitizer can be added by the user. The sanitizer can sanitize the working end 3 after use when the working end is inserted into the holster 7.

Alternatively, the tool 1 can include a pad configured to be disposed within the holster 7, along one side or the end of the holster 7 interior, or forming an interior pouch into which at least the working end 3 is inserted. The pad can be further configured to absorb an antimicrobial liquid, or can include the antimicrobial liquid, infused within the pad. Alternatively, the pad itself can be fabricated from an antimicrobial fabric. The antimicrobial substance can neutralize any contaminant that adheres to the working end 3 after use when the working end is inserted into the holster 7.

Alternatively, or in addition, the pad can be further configured to absorb a sanitizer. The tool 1 can include the sanitizer, infused within the pad, or the sanitizer can be added by the user. The sanitizer can sanitize the working end 3 after use when the working end is inserted into the holster 7.

The tool 1 can include a pouch configured to be disposed within the holster 7, such as a mesh pouch or mesh retaining net. The pouch can be configured to contain one or more antimicrobial pellets, that is, pellets made of antimicrobial material. The tool 1 can include the one or more antimicrobial pellets, contained in the pouch.

Ultraviolet light is also known to have disinfecting powers, and is effective at killing bacteria, fungi, and viruses. In particular, light having a wavelength of between about 200 and about 280 nanometers is a potent antimicrobial. To take advantage of this property, an interior of the holster 7 can include an ultraviolet light source, either lining the sides if the interior, at the closed end of the interior, or both. The holster 7 can also include a battery configured to power the ultraviolet light source. The battery can be a rechargeable battery, and the holster 7 can include a port by which the battery can be coupled to a power source, such as a USB port.

Further, the holster 7 can include an illuminating light source configured to shine outward from the holster 7, to facilitate use of the tool in the dark or in dim light. The holster 7 can include a rechargeable battery for the light, and a port by which the battery can be coupled to a power source. If the illuminating light and the ultraviolet light are both included, the battery and charging port can be shared between the lights, or separate batteries and charging ports can be included.

Likewise, the grip end 2, the working end 3, and/or the connector 4 can include a light source configured to shine outward from the tool 1, a rechargeable battery, and a port by which the battery can be coupled to a power source, whether or not the tool 1 includes the holster 7. Preferably, the light source is arranged on the working end 3 to illuminate the door element to be manipulated by the user using the tool 1, and is connected to a power switch on the grip end 2 which can be used to power the light on and off. If the tool 1 also includes the holster 7, a mutually-engaging cooperative interlock can be included so that when the working end 3 is pulled from the holster 7 the light automatically turns on, and turns back off when the working end 3 is returned to the holster 7.

The holster 7 can include a loop or aperture configured to be coupled to a keychain, to a belt chain, or to anything else for the convenience of the user. The holster 7 can be configured to be coupled to the grip end 2, such as by a tether, to prevent either from getting misplaced during use.

The connector 4, or any other portion of the tool 1, including the holster 7, can include indicia configured to measure a distance between two points. For example, a ruler can be printed, embossed, impressed, or otherwise marked on any portion of the tool 1, such as the connector 4 or holster 7, for handy use as a measuring tool 1.

The present invention has been described by way of example and in terms of preferred embodiments. However, the present invention as contemplated by the inventor is not strictly limited to the particularly disclosed embodiments. To the contrary, various modifications, as well as similar arrangements, are included within the spirit and scope of the present invention. The invention, therefore, should be accorded the broadest reasonable interpretation so as to encompass all such modifications and similar arrangements.

I claim:

1. A door manipulation tool, comprising:
a grip end;
a working end; and
a connector;
wherein the grip end is configured to be gripped by a user;
wherein the working end is configured to contact and grasp a door element; and
wherein the connector is configured to maintain a spaced relation between the grip end and the working end.

2. The tool of claim 1, wherein the grip end is a handle.

3. The tool of claim 1, wherein the grip end includes a loop configured to be held by a finger.

4. The tool of claim 1, wherein the grip end includes a loop configured to be coupled to a key chain.

5. The tool of claim 1, wherein the working end includes a hook.

6. The tool of claim 1, wherein the working end includes a loop.

7. The tool of claim 1, wherein the working end includes a grabber.

8. The tool of claim 1, wherein the working end includes a prod.

9. The tool of claim 1, wherein at least the working end is fabricated at least in part from an antimicrobial material.

10. The tool of claim 9, wherein the antimicrobial material is selected from the group consisting of gold, silver, copper, alloys of copper, cobalt, nickel, zinc, zirconium, molybdenum, and lead.

11. The tool of claim 9, wherein the antimicrobial material is an antiviral material.

12. The tool of claim 1, wherein at least the working end is plated at least in part with an antimicrobial material.

13. The tool of claim 12, wherein the antimicrobial material is selected from the group consisting of gold silver, copper, alloys of copper, cobalt, nickel, zinc, zirconium, molybdenum, and lead

14. The tool of claim 12, wherein the antimicrobial material is an antiviral material.

15. The tool of claim 1, further comprising an antimicrobial fabric covering configured to closely cover at least the working end.

16. The tool of claim 1, further comprising a disposable covering configured to closely cover at least the working end.

17. The tool of claim 1, further comprising a holster configured to contain at least the working end.

18. The tool of claim 17, further comprising a closure element arranged between the grip end and the connector, which is configured to couple with an opening of the holster.

19. The tool of claim 18, wherein the closure element and the working end are mutually arranged as a bottle opener.

20. The tool of claim 17, wherein the holster is a rigid case.

21. The tool of claim 17, wherein the holster includes fabric.

22. The tool of claim 21, wherein the fabric is an antimicrobial fabric.

23. The tool of claim 17, wherein an interior of the holster includes a fabric lining that is configured to absorb and release an antimicrobial substance.

24. The tool of claim 23, wherein the antimicrobial substance is at least one of a liquid and a powder.

25. The tool of claim 23, further comprising the antimicrobial substance, infused within the fabric lining.

26. The tool of claim 17, further comprising a pad configured to be disposed within the holster.

27. The tool of claim 26, wherein the pad is further configured to absorb an antimicrobial substance.

28. The tool of claim 23, wherein the antimicrobial substance is at least one of a liquid and a powder.

29. The tool of claim 27, further comprising the antimicrobial substance, infused within the pad.

30. The tool of claim 26, wherein the pad is fabricated from an antimicrobial fabric.

31. The tool of claim 26, wherein the pad is further configured to absorb a sanitizer.

32. The tool of claim 31, further comprising the sanitizer, infused within the pad.

33. The tool of claim 17, wherein an interior of the holster includes a fabric lining that is configured to absorb and release a sanitizer.

34. The tool of claim 33, further comprising the sanitizer, infused within the fabric lining.

35. The tool of claim 17, further comprising a pouch configured to be disposed within the holster.

36. The tool of claim 35, wherein the pouch is further configured to contain one or more antimicrobial pellets.

37. The tool of claim 36, further comprising the one or more antimicrobial pellets, contained in the pouch.

38. The tool of claim 17, wherein the holster includes a loop configured to be coupled to a keychain.

39. The tool of claim 17, wherein the holster is configured to be coupled to the grip end.

40. The tool of claim 17, wherein an interior of the holster includes an ultraviolet light source,

41. The tool of claim 40, wherein the holster includes a battery configured to power the ultraviolet light source.

42. The tool of claim 41, wherein the battery is a rechargeable battery, and the holster includes a port by which the battery can be coupled to a power source,

43. The tool of claim 17, wherein the holster includes:
a light source configured to shine outward from the holster;
a rechargeable battery; and
a port by which the battery can be coupled to a power source.

44. The tool of claim 1, wherein at least one of the grip end, the working end, and the connector includes:
a light source configured to shine outward from the tool;
a rechargeable battery; and
a port by which the battery can be coupled to a power source.

45. The tool of claim 44, wherein the light source is arranged on the working end.

46. The tool of claim 1, wherein the connector includes indicia configured to measure a distance between two points.
